(19) United States
(12) Patent Application Publication
(10) Pub. No.: US 2010/0031248 A1
(43) Pub. Date: Feb. 4, 2010

(54) Installation Sequence Manager

(75) Inventors: Dmitry Sonkin, Redmond, WA (US); Marc Greisen, Snohomish, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/184,238

(22) Filed: Jul. 31, 2008

(51) Int. Cl. G06F 9/445

(52) U.S. Cl. 717/174

(57) ABSTRACT

An installation manager may have a user interface that may enable a user to modify the execution of an installation sequence. A user may indicate an installation step or task within a step that may for pausing the sequence, skipping the step or task, repeating a step or task, or closely monitoring a specific step or task. The user's modifications to the installation sequence may be presented in the user interface, and the modifications may persist even when a system reboot operation is performed during the sequence. The installation manager may enable a user to augment the installation sequence by pausing the sequence, inspecting an item or performing an additional task, and resuming the sequence.

### BACKGROUND

Installation of complex or interrelated computer components may involve many operations that are performed in sequence. Due to differences in computing environments, hardware, existing software and services, and other factors, a long and complex sequence may be difficult to define such that the sequence may be successfully executed with sometimes substantial differences between installation environments.

### SUMMARY

An installation manager may have a user interface that may enable a user to modify the execution of an installation sequence. A user may indicate an installation step or task within a step that may for pausing the sequence, skipping the step or task, repeating a step or task, or closely monitoring a specific step or task. The user's modifications to the installation sequence may be presented in the user interface, and the modifications may persist even when a system reboot operation is performed during the sequence. The installation manager may enable a user to augment the installation sequence by pausing the sequence, inspecting an item or performing an additional task, and resuming the sequence.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a diagram illustration of an embodiment showing a system for performing installation sequences.

FIG. 2 is a flowchart illustration of an embodiment showing a method for processing installation steps.

FIG. 3 is a flowchart illustration of an embodiment showing a method for executing installation steps with sequence modifiers.

FIG. 4 is a diagram illustration of an example embodiment showing a user interface for sequence management with sequence modifiers.

FIG. 5 is a diagram illustration of an example embodiment showing a user interface for sequence management with sequence modifiers showing a paused sequence.

FIG. 6 is a diagram illustration of an example embodiment showing a user interface for sequence management with sequence modifiers showing a repeated step and a skipped step.

### DETAILED DESCRIPTION

A system for managing installation sequences may accept and perform various modifiers to the sequence, such as pause and resume operations, skip operations, repeat operations, jump operations, and other modifiers. The sequence modifiers may enable a user to manage complex and lengthy installation sequences, and may allow a user to perform various operations in the middle of a sequence outside of the installation operations.

One or more installation steps may be gathered together and organized as an installation sequence. In many embodiments, each installation step may be composed of many tasks. After organizing the steps together as a sequence, the sequence may be presented to a user through a user interface. The user may interact with the sequence using various graphical user interface mechanisms, and the user may add various modifiers to the sequence. The modifiers may affect how the sequence is actually performed. In some embodiments, modifiers may be added to the sequence once the sequence is launched.

The modifiers may enable a user to set a stop point within a sequence. A stop point may pause the sequence and enable the user to perform other operations outside the sequence. For example, the user may set a pause point or stop point in a sequence, execute the sequence to the stop point, and then inspect the installation effects, run another application, or perform some manual configuration. When the user has completed the other tasks, the user may cause the sequence to resume or may abort the remaining portion of the installation sequence.

The modifiers may enable a user to repeat or skip one or more steps in a sequence. In some embodiments, a repeat modifier may be set to endlessly repeat a sequence until interrupted or repeat a step for a set number of times. Some embodiments may enable a user to skip one or more installation steps. Some embodiments may implement a skip operation with a jump modifier that indicates the sequence may jump to another step, omitting some steps in the process.

The various modifiers may enable a user to diagnose problems with a setup or installation sequence, manually perform some operations of an installation sequence, and otherwise intervene in an installation process.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by an instruction execution system. Note that the computer-usable or computer-readable medium could be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

When the subject matter is embodied in the general context of computer-executable instructions, the embodiment may comprise program modules, executed by one or more systems, computers, or other devices. Generally, program modules include routines, programs, objects, components, data structures, etc. that perform particular tasks or implement particular abstract data types. Typically, the functionality of the program modules may be combined or distributed as desired in various embodiments.

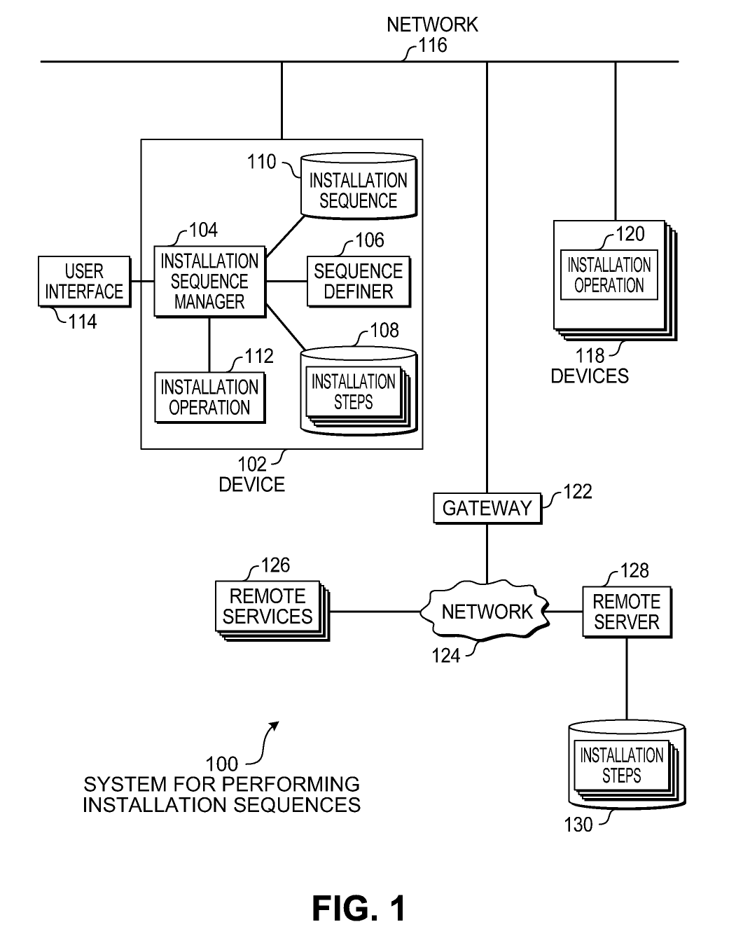

FIG. 1 is a diagram of an embodiment 100 showing an installation system that may use sequence modifiers. Embodiment 100 is a simplified example of an installation system that may be used to install and configure various components on a local system, systems connected through a local area network, and systems available through a wide area network. The various components may be installed using an installation sequence that may be modified prior to or during operation.

The diagram of FIG. 1 illustrates functional components of a system. In some cases, the component may be a hardware component, a software component, or a combination of hardware and software. Some of the components may be application level software, while other components may be operating system level components. In some cases, the connection of one component to another may be a close connection where two or more components are operating on a single hardware platform. In other cases, the connections may be made over network connections spanning long distances. Each embodiment may use different hardware, software, and interconnection architectures to achieve the functions described.

Embodiment 100 is an example of a system that may manage multiple installation operations. In a typical use scenario, a system may gather multiple installation steps, organize the steps into a sequence, and cause the installation steps to be performed. The installation steps may install and configure various applications, services, hardware components, or other components in a computing environment. In some embodiments, an installation step may configure a remotely hosted service or application to execute on a local device or another device within a local area network.

The device 102 may have an installation sequence manager 104 that may execute or cause to execute an installation sequence 110. The installation sequence manager 104 may provide a central point of management for multiple installation steps 108.

In many embodiments, an installation step 108 may be predefined to install and configure a single application, service, or other component. In other embodiments, multiple installation steps may be used to install and configure a single component. In still other embodiments, a single installation step may install and configure multiple components.

An installation step 108 may be any mechanism through which an installation or configuration function may be performed. In many embodiments, an installation step or task may be a script, executable program, batch file, installation package, or other mechanism by which a function may be performed. In some cases, an installation sequence manager 104 may be capable of executing an installation step itself such as with an internal scripting environment or executable environment. In other cases, an installation sequence manager 104 may be capable of launching an installation step or task on the device 102 or on other devices 118 that may be accessible through a network 116.

An installation step may be made up of multiple tasks. Each task may be a separate operation that may be performed within the installation step. In some embodiments, an installation step may expose tasks to a user for sequence modifiers.

A sequence definer 106 may be used to select a group of installation steps 108 and organize the selected installation steps into an installation sequence 110. In some embodiments, the sequence definer 106 may be able to access a remote server 128 that may have additional or updated installation steps 130.

The remote server 128 may be accessed from a local area network 116, through a gateway 122 and another network 124 that may be a wide area network such as the Internet.

In some cases, an installation step may have dependencies on another installation step. In such a case, the installation steps may be arranged in order so that one installation step is performed before a second installation step, when the second installation step is dependent on the first.

In an example, a single installation step may be selected to install a single component. The selected installation step may be dependent on several other installation steps. In such a case, the sequence definer 106 may gather the other installation steps and arrange an installation sequence 110 that includes all of the identified installation steps arranged so that the dependent installation steps may be performed before the selected installation step.

An installation step may include various installation operations. The installation sequence manager 104 may cause a local installation operation 112 to be performed. In some cases, the installation sequence manager 104 may cause an installation operation 120 to be performed on a device 118 that may be connected through a network 116. The installation operations may be executable operations that are launched or caused to happen by the installation steps.

In some embodiments, an installation step may include configuring device 102 or remote devices 118 to operate with remote services 126. Remote services 126 may be any application or service that is available through the network 124. Examples may include mail services, line of business applications, or other services that are hosted on the Internet and to which a user may have access. In some cases, remote services 126 may be background services that may be used by a server or client device on a local area network 116. In many cases, remote services 126 may be configured by establishing an authentication method and credentials for authentication, and some services may have a locally operating executable client such as a thin client architecture. Many different architectures may be used with remote services 126.

The installation sequence manager 104 may enable a user, such as a system administrator, to manage an installation process through a user interface 114. The installation sequence manager 104 may enable the user to interact with the installation sequence 110 by presenting the installation sequence 110 and allowing the user to add various sequence modifiers to the installation sequence 110.

A sequence modifier may be various changes that may be permitted to an installation sequence. Examples of sequence modifiers may include stop points, repeat operations, jump operations, skip operations, and other modifiers. By setting one or more sequence modifier within the user interface 114, the user may control and modify the flow of the installation sequence 110 for various purposes.

One use for sequence modifiers is to pause the sequence to manually verify items at a point during the installation sequence and manually perform an operation prior to resuming the sequence. A stop point may be inserted in the sequence and the sequence caused to execute. When the sequence reaches the stop point, the user may be able to check a variable, test the installation, or perform other manual actions while the sequence is paused. In some cases, the user may be able to perform other installation operations, such as launching an installation operation manually. The installation sequence 110 may continue when the user indicates on the user interface 114.

Another use for a sequence modifier may be to skip an installation step or task. Prior to executing a specific task or installation step, the user may modify the installation sequence to skip the particular step. Such a modification may be useful when an installation process has failed in the past at the particular step or because of the particular step. By skipping the step, a complex installation sequence may be completed without errors from the skipped step.

A repeat modifier may be used to modify an installation sequence. The repeat indicator may cause a particular step or group of steps to be repeated once, several times, or an unlimited number of times. A repeat modifier may be useful in cases where an installation step may be performed two or more times. In cases where an installation step may be performed an unlimited number of times, a user may pause the execution during a repetition and remove the repeat modifier to allow the installation sequence to continue.

Some embodiments may enable a jump modifier. A jump modifier may be defined to jump from one installation step to another installation step. In many cases, the jump modifier may be used to skip multiple steps as a group. In some cases, the jump modifier may be used to create a loop by indicating a group of installation steps to repeat. In such a case, the jump indicator may point to another installation step prior to the jump indicator. In the case where a jump modifier may be used to skip a group of installation steps, the jump modifier may point to another installation step after the jump indicator.

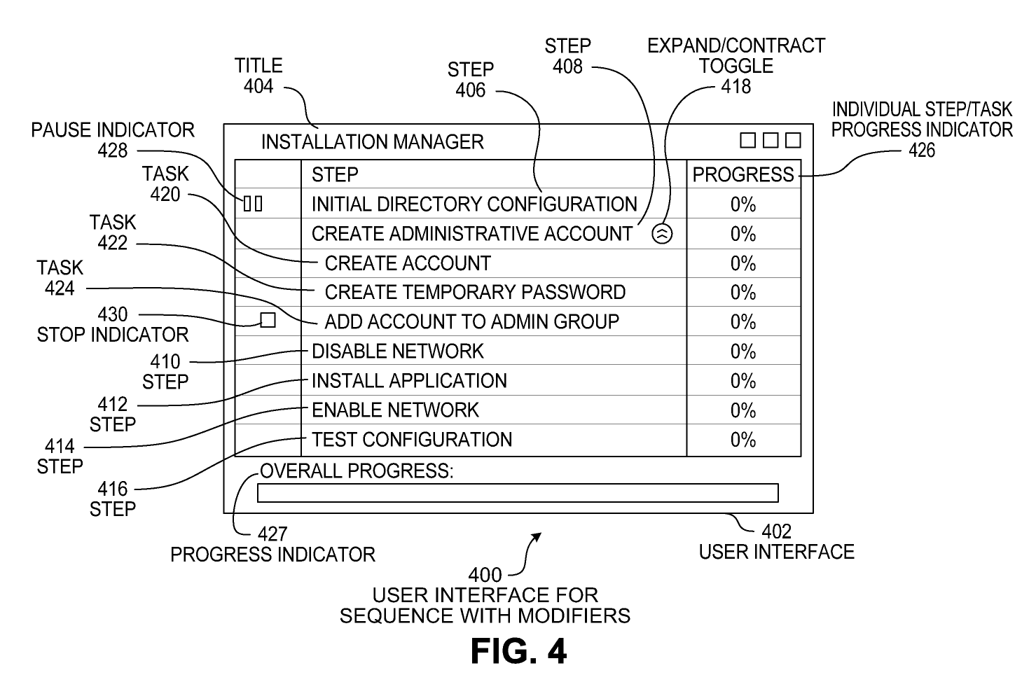

The user interface 114 may be a graphical user interface on which a user may place various modifiers, indicate when the sequence is to start, interrupt an ongoing sequence, or perform other modifications and otherwise manage an installation sequence. Examples of such a user interface may be found in FIGS. 4, 5, and 6 of this specification.

In many embodiments, the installation sequence manager 104 may be capable of storing sequence modifiers and persisting the sequence modifiers when the device 102 is restarted or rebooted. In many installation sequences, a reboot or restart operation may be used to restart one or more processes or services with updated configuration parameters, or perform other functions. In such embodiments, the installation sequence manager 104 may continue an installation sequence after a restart or reboot, and may apply any sequence modifiers that existed prior to the restart or reboot operation.

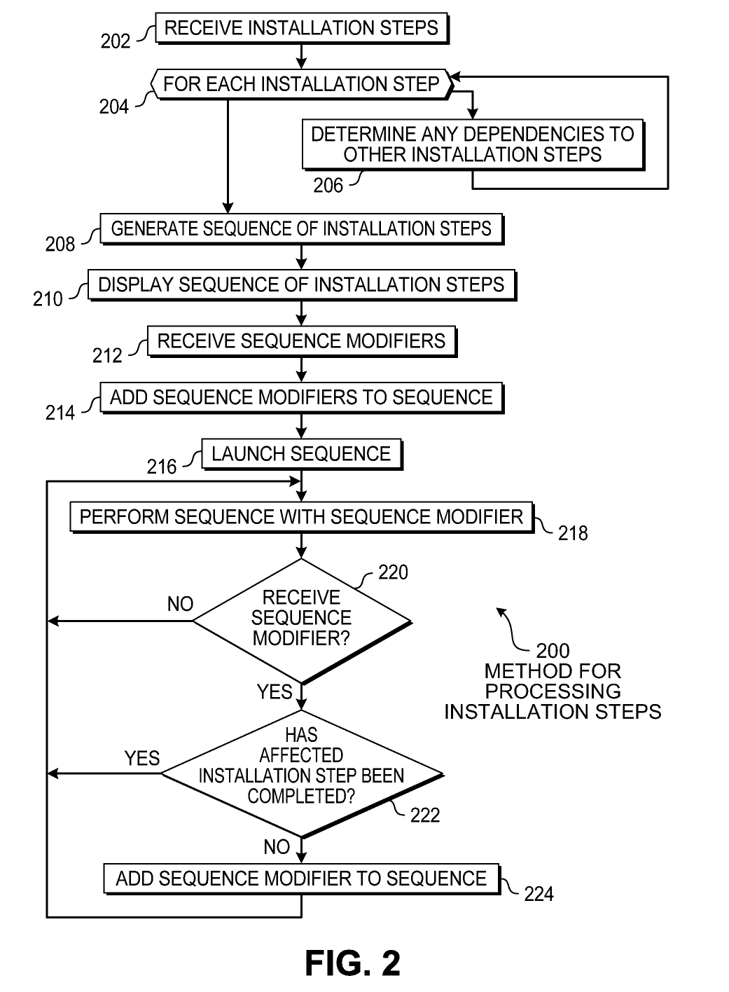

FIG. 2 is a flowchart illustration of an embodiment 200 showing a method for processing installation steps. Embodiment 200 is a simplified example of organizing installation steps then causing the installation steps to be performed according to sequence modifiers that may be added to the sequence both prior to starting the sequence and during sequence operation.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Installation steps may be received in block 202. The identification and selection of installation steps may be performed using many different mechanisms. In some cases, a user may launch an installation manager using a script or a selected installation step. In other cases, a user may select from a list of available installation steps. After selecting one or more installation steps, an installation manager may identify additional installation steps that may be related to the selected installation steps.

Some embodiments may include an environmental scanner, installation database, or other technology for determining which installation steps would be related or relevant to a selected installation step.

After the group of installation steps are identified and received in block 202, each installation step may be individually processed in block 204. For each installation step in block 204, any dependencies to other installation steps may be determined in block 206. After processing each installation step in block 204, a sequence of installation steps may be generated in block 208 using the dependencies determined in block 206.

In some embodiments, the process of blocks 204 and 206 may identify additional installation steps that may be added to the sequence.

The sequence of installation steps may be a linear sequence, or may be a more complex flow. The term installation sequence or sequence of installation may be used to refer to any organization of installation steps or tasks that may be performed. In some cases, the sequence may be a linear sequence where one step or task is completed before a second step or task begins. In other cases, two or more steps or tasks may be performed simultaneously. Some embodiments may have branched steps where a condition or set of conditions may be evaluated to determine which step or task to perform next.

Some embodiments may include installation steps that involve processes that operate on different devices within a local area network or may involve processes that operate on devices connected through a wide area network including the Internet.

The sequence of installation steps may be presented on a user interface in block 210. The user interface may be any type of user interface, including graphical user interfaces that may have a monitor and various input devices such as pointing devices and keyboards.

Using the user interface of block 210, various sequence modifiers may be received in block 212 from the user. The sequence modifiers may be various changes that a user may be permitted to make to a sequence. Some embodiments may permit some sequence modifiers while other embodiments may permit other sequence modifiers.

Examples of sequence modifiers include pause or stop indicators. A pause indicator may be used to suspend the operation of a sequence at a particular point. A user may cause a resume operation to be performed where the sequence may continue from the paused location.

Another example of a sequence modifier may be a skip indicator. A skip indicator may be used to skip one or more steps or tasks. Still another example may be a repeat indicator where a step or group of steps may be repeated once, twice, a fixed number of times, or an indefinite number of times.

In many embodiments, a user may be able to interact with a user interface by highlighting or otherwise indicating a position within a sequence, and adding a sequence modifier. One common mechanism for doing such an action may involve selecting a step and selecting a sequence modifier to add from a menu of available modifiers. In some embodiments, such a menu may be presented to a user by using a secondary mouse button.

In some embodiments, a sequence modifier may include repositioning or re-sequencing one or more steps or tasks. In such an embodiment, a user may be able to change the sequence of the steps that are performed.

In some cases, a user may elect not to add any sequence modifiers in block 214.

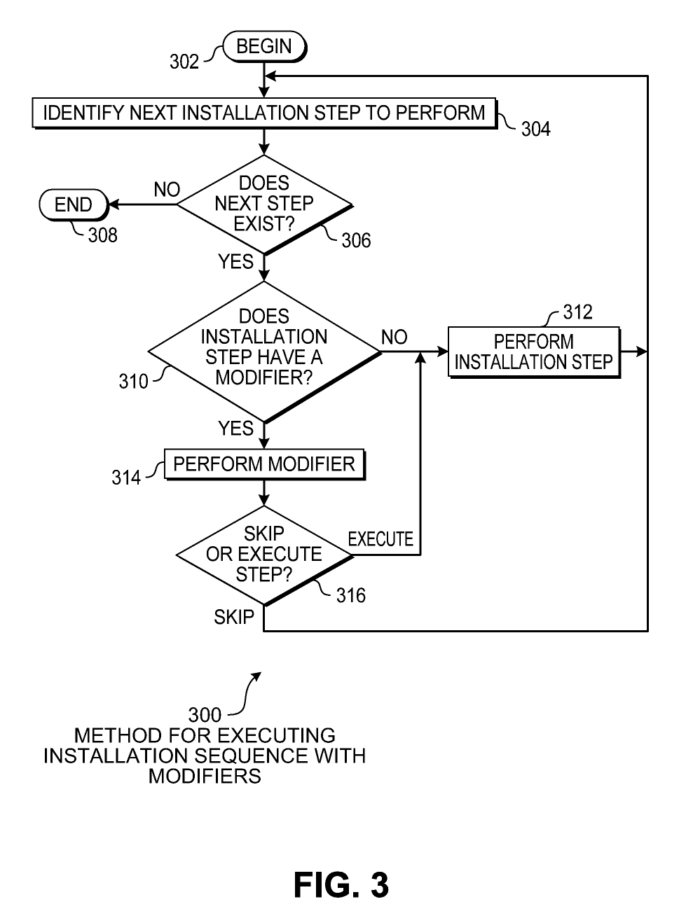

The installation sequence may be launched in block 216. When launched, the steps or tasks as defined in the sequence may be performed with the sequence modifiers in block 218. In block 218, a sequence modifier may change the behavior of the sequence, such as pausing the sequence, repeating a step, or other modifications. A more detailed example may be shown in FIG. 3 of this specification.

During the operation, a user may interact with the user interface and may add sequence modifiers. If a sequence modifier has been received in block 220, and the affected installation step has not yet been completed in block 222, the sequence modifier may be added to the sequence in block 224. If the sequence modifier is attempted to be added to an installation step in block 222 that has already been completed, the sequence modifier may be ignored.

FIG. 3 is a flowchart illustration of an embodiment 300 showing a method for executing an installation sequence with modifiers. Embodiment 300 is a simplified example of a mechanism for processing sequence modifiers along with the step of an installation sequence. Embodiment 300 is an example of the process that may occur during the operational sequence of block 218 in embodiment 200.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

The operation of embodiment 300 may begin in block 302.

The next installation step to perform may be identified in block 304. If a next step does not exist in block 306, the process may end in block 308.

A next installation step may be selected from a sequence of installation steps, such as the sequence that may be defined in block 208 of embodiment 200. In some cases, the next installation step may be identified after a previous step has been completed. In other cases, the next installation step may be identified while another installation step is being performed.

If the installation step exists in block 306 and no sequence modifier has been associated with the step in block 310, the installation step may be performed in block 312. The process may return to block 304.

If the installation step does have a sequence modifier in block 310, the modifier may be performed in block 314. Each sequence modifier may have a particular way the sequence modifier may be performed. In the case of a pause or stop modifier, the modifier may be performed by pausing the installation sequence. When a user indicates that the installation is to continue, the sequence modifier may then indicate that the installation step is to be executed in block 316 and the installation step may be performed in block 312. The process may return to block 304.

In another example, a sequence modifier may be to skip an installation step. In such a case, the results of the modifier performance in block 314 may be to skip the installation step in block 316, and the process may return to block 304.

FIG. 4 is a diagram illustration of an example embodiment 400 illustrating a user interface for an installation sequence with sequence modifiers. Embodiment 400 is an example of some of the elements that may be present in a user interface.

The user interface 402 may represent a window or display on a graphical user interface. The user interface 402 may have a title 404, and may display the various installation steps 406, 408, 410, 412, 414, and 416 according to an installation sequence.

The various steps may be displayed by presenting a short name for the step. In some cases, graphical icons or images may be used to illustrate the steps. In some cases, a button or hot zone may be used to toggle an expanded description of the steps. An expanded description may include detailed descriptions of the step, dependencies of the step, input parameters, output parameters, and other details.

The step 408 is illustrated with an expand/contract toggle 418. When the expand/contract toggle 418 is activated, the tasks 420, 422, and 424 may be displayed. The illustrated tasks may make up the step 408.

Each step or task may have a progress indicator in a column for individual step or task progress indicators 426. An overall progress indicator 427 may present the overall completion of the sequence.

Step 406 is illustrated with a pause indicator 428. The pause indicator may illustrate that the installation sequence is not currently operating and that if the installation sequence were to continue, step 406 would be the next step executed. The pause indicator may be a sequence modifier and may also be a user input mechanism. In some cases, a user may click on the pause indicator 428 to continue the sequence.

In some embodiments, the pause indicator 428 may be used to launch the sequence. In other embodiments, a set of buttons or other controls may be used to start, stop, pause, continue, or otherwise control the execution of the installation sequence.

Task 424 is illustrated with a stop indicator 430. The stop indicator 430 may be an example of a sequence modifier that may pause or stop the installation sequence at task 424 within step 408. The stop indicator 430 may be added to the user interface 402 prior to launching the installation sequence.

Embodiment 400 illustrates an embodiment where sequence modifiers are presented to the user as graphic icons. Other embodiments may have different manners of presenting sequence modifiers to a user and indicating the presence and the affected step or task within an installation sequence.

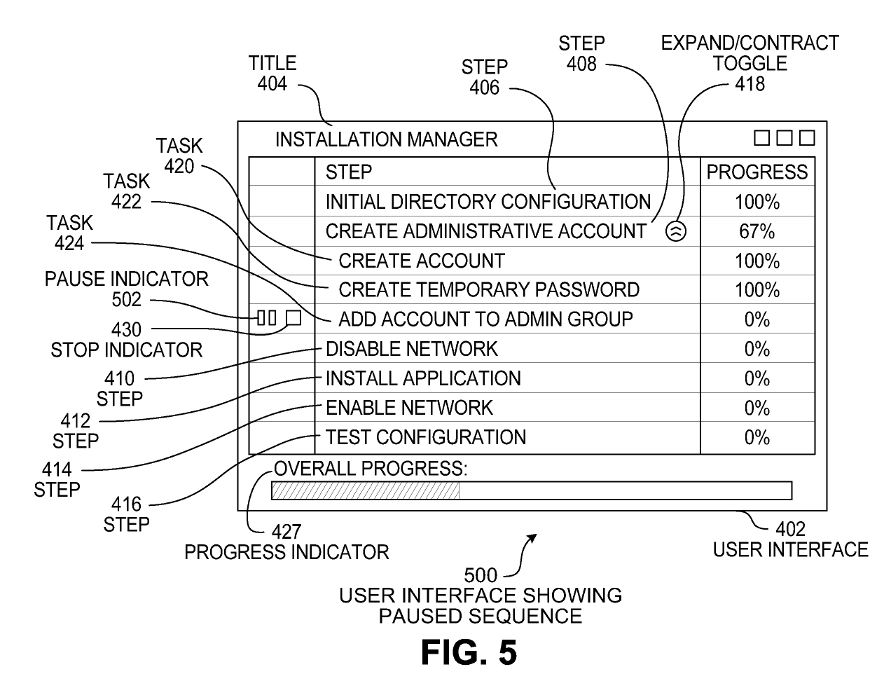

FIG. 5 is a diagram illustration of an example embodiment 500 illustrating a user interface for an installation sequence when the sequence is in a paused state. Embodiment 500 illustrates the embodiment 400 after the installation sequence has progressed to the stop indicator 430.

In embodiment 500, the user interface 402 shows an installation sequence that has progressed until the stop indicator 430. At the point illustrated by embodiment 500, the installation sequence has completed steps 406, and tasks 420 and 422 of step 408. The progress indicator 427 shows about a third of the overall progress is completed.

The stop indicator 430 is located at task 424. Next to the stop indicator 430 is a pause indicator 502. The pause indicator 502 indicates that the installation sequence has been stopped. The pause indicator 502 may be toggled by a user to cause the installation sequence to continue with task 424.

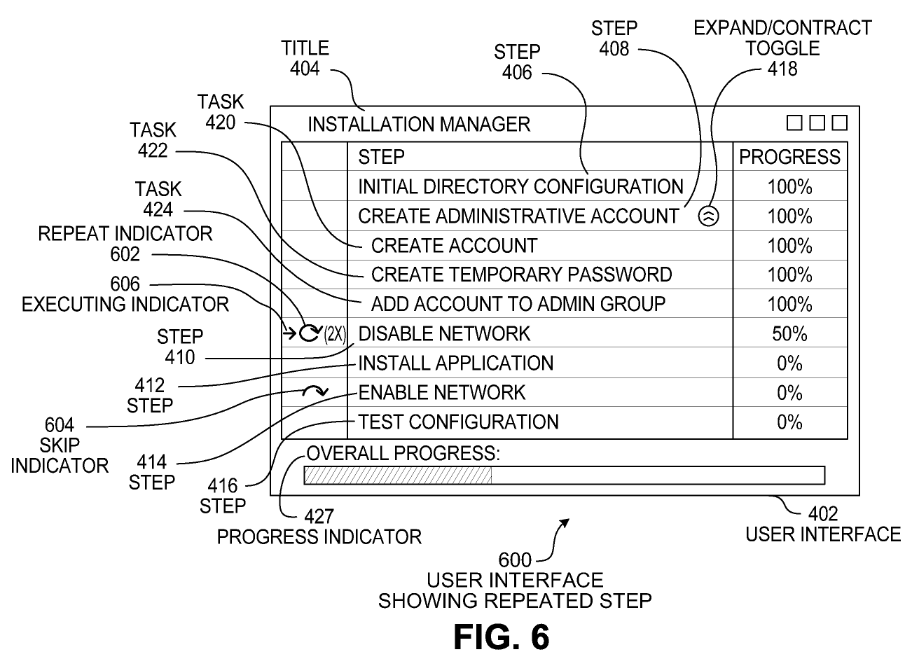

FIG. 6 is a diagram illustration of an example embodiment 600 illustrating a user interface for an installation sequence when the sequence includes a repeated step sequence modifier. Embodiment 600 illustrates the embodiment 500 after the installation sequence has continued to operate and after a user has added a repeat indicator.

In embodiment 600, the user interface 402 shows an installation sequence that is performing step 410 in a repeated fashion. A repeat indicator 602 is shown next to the step 410. The repeat indicator 602 is illustrated with a ‘2×’ indicator which may show that the step is to be repeated two more times.

The executing indicator 606 is illustrated at step 412 and may show that step 412 is currently executing.

Step 414 has a skip indicator 604. The skip indicator 604 may show that step 414 may be omitted when the executing sequence reaches step 414.

Embodiments 400, 500, and 600 may illustrate the progression of an installation sequence within a user interface. A user may modify the installation sequence by placing sequence modifiers in the user interface, with the sequence modifiers attached to or referencing a step or task of the installation sequence. The sequence modifiers may be used to pause a sequence, skip or repeat steps or tasks, or perform other changes to an installation sequence.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

What is claimed is:

1. A method comprising:
receiving a sequence of installation steps to be performed;
presenting said installation steps in a user interface according to said sequence;
receiving a pause indicator input, said pause indicator input being related to a first of said installation steps;
causing said sequence to be performed by causing said installation steps to be performed;
when said first of said installation steps is reached in said sequence, pausing said sequence prior to performing said first of said installation steps; and
receiving a resume indicator and resuming said sequence with said first of said installation steps.

2. The method of claim 1, said sequence comprising at least two of said installation steps that are to be performed in parallel.

3. The method of claim 1, said user interface being presented on a first device, and at least one of said installation steps being performed by a second device.

4. The method of claim 1, said user interface being generated by a first device, and at least one of said installation steps being performed by a second device.

5. The method of claim 1, at least one of said installation steps comprising a system reboot.

6. The method of claim 1 further comprising:
receiving a repeat indicator input, said repeat indicator input being related to a second installation step; and
performing said second installation step at least twice when performing said sequence.

7. The method of claim 1 further comprising:
receiving a skip indicator input, said skip indicator input being related to a second installation step; and
omitting said second installation step when performing said sequence.

8. The method of claim 1, said pause indicator being received prior to said causing said sequence to be performed.

9. The method of claim 1, said pause indicator being received after said causing said sequence to be performed.

10. The method of claim 1, at least one of said installation steps having a plurality of tasks.

11. The method of claim 10 further comprising:
receiving an expand input, said expand input being related to a second installation step; and
presenting a plurality of tasks comprised in said second step in said user interface.

12. The method of claim 11 further comprising:
receiving a second pause indicator, said second pause indicator being related to a first of said tasks within said second installation step; and when said first of said tasks is reached in said sequence, pausing said sequence prior to performing said first of said tasks.

13. A system comprising:
a user interface;
a sequence of installation steps ; and
an installation sequence manager configured to perform a method comprising:
presenting said installation steps in said user interface according to said sequence;
receiving a pause indicator input, said pause indicator input being related to a first of said installation steps;
causing said sequence to be performed by causing said installation steps to be performed;
when said first of said installation steps is reached in said sequence, pausing said sequence prior to performing said first of said installation steps; and
receiving a resume indicator and resuming said sequence with said first of said installation steps.

14. The system of claim 13 further comprising:
a sequence definer configured to generate said sequence of installation steps by a method comprising:
gathering a plurality of installation steps;
determining a dependency between a first step and a second step; and
generate said sequence based on said dependency.

15. The system of claim 13, at least one of said installation steps comprising a system reboot.

16. The system of claim 15, said installation sequence manager being operated on a first device and said at least one of said installation steps being operated on said first device.

17. A computer readable storage medium comprising computer executable instructions configured to perform a method comprising:
gathering a plurality of installation steps to be performed;
determining a sequence of said installation steps;
presenting said installation steps in a user interface according to said sequence;
receiving a pause indicator input, said pause indicator input being related to a first of said installation steps;
causing said sequence to be performed by causing said installation steps to be performed;
when said first of said installation steps is reached in said sequence, pausing said sequence prior to performing said first of said installation steps; and
receiving a resume indicator and resuming said sequence with said first of said installation steps.

18. The computer readable storage medium of claim 17, said method further comprising:
receiving a skip indicator input, said skip indicator input being related to a second installation step;
evaluating said skip indicator to determine that a skip is permitted for said second installation step; and
omitting said second installation step when performing said sequence.

19. The computer readable storage medium of claim 17, said method further comprising:
receiving a skip indicator input, said skip indicator input being related to a second installation step;
evaluating said skip indicator to determine that a skip is not permitted for said second installation step; and
performing said second installation step when performing said sequence.

20. The computer readable storage medium of claim 19, said method further comprising:
presenting an indicator on said user interface indicating that said second installation may not be skipped.
